(19) United States
(12) Patent Application Publication
(10) Pub. No.: US 2026/0298863 A1
(43) Pub. Date: Oct. 1, 2026

(54) GAMMA-STERILIZABLE pH SENSOR WITH IMPROVED STABILITY AGAINST HIGHER PRESSURE AND FLOW

(71) Applicant: ROSEMOUNT INC, Shakopee, MN (US)

(72) Inventors: Ye LIN, Eden Prairie, MN (US); Kelly MITZEL, Bloomington, MN (US); Chad M. MCGUIRE, Shakopee, MN (US); Rick J. SUMRALL, Eden Prairie, MN (US)

(21) Appl. No.: 19/093,454

(22) Filed: Mar. 28, 2025

(51) Int. Cl. G01N 27/30; G01N 27/36

(52) U.S. Cl. CPC G01N 27/302; G01N 27/301; G01N 27/36

(57) ABSTRACT

A pH sensor includes a sensor body, a pH electrode and a reference electrode. The pH electrode is disposed within the sensor body and is configured to be exposed to a liquid. The reference electrode has an electrolyte therein and includes a reference junction in contact with the electrolyte and configured to contact the liquid. The reference junction is shaped as a ring and formed of a gamma-sterilizable material.

### BACKGROUND

pH is defined as the negative logarithm of the concentration of hydrogen ions. pH is on a scale of 0-14 and pH values less than 7 confirm acidic conditions in the process, while pH values greater than 7 confirm basic conditions. Typical strong acids such as hydrochloric acid (stomach acid) and battery acid (sulfuric acid) have pH values less than 1 and are very corrosive. Similarly, strong bases such as caustic or bleach and drain cleaners have pH values greater than 13 and are also very corrosive. The pH value of pure water is 7.

The biopharmaceutical market makes extensive use of pH sensing systems and is increasingly embracing single-use components to drive down capital and operational costs, mitigate contamination risks, expedite drug research timelines, and enhance manufacturing plant flexibility. This shift is fueled by the pharmaceutical industry's pivot towards personalized drug production and smaller batch sizes, necessitating the adoption of single-use instrumentation (SUI) methods.

However, traditional pH sensors may be limited in SUI applications due to their vulnerability to gamma radiation and limited shelf life. While some commercially-available single-use pressure sensors have been designed to include gamma stable materials and employ wet storage techniques using stable phosphate buffers, such offerings are typically designed for “upstream” in-bag applications and thus are subject to minimal pressure (<5 psi) and no flow. When such sensors are subjected to higher pressures (5-90 psi) and flow rates typical of “downstream” and in-line processes, instability of the pH sensor reading may be observed.

Accordingly, providing a gamma stable, single-use pH sensor that could provide stable readings with higher pressures and flow rates would allow the biopharmaceutical industry as well as other industries to make greater use of such SUI pH sensors.

### SUMMARY

A pH sensor includes a sensor body, a pH electrode and a reference electrode. The pH electrode is disposed within the sensor body and is configured to be exposed to a liquid. The reference electrode has an electrolyte therein and includes a reference junction in contact with the electrolyte and configured to contact the liquid. The reference junction is shaped as a ring and formed of a gamma-sterilizable material.

### BRIEF DESCRIPTION OF THE DRAWINGS

FIG. 1 is a diagrammatic view illustrating basics of pH measurement.

FIG. 2A is a diagrammatic view of a known reference electrode.

FIGS. 2B and 2C are diagrammatic views of electrolyte flow through a reference junction of a known reference electrode in a no pressure/flow condition (FIG. 2B) and a pressure/flow condition (FIG. 2C).

FIG. 2D is a chart of pH sensor response to varying process fluid pressures.

FIG. 3 is a chart of reference chamber pressure decay for a reference electrode that employs pressurization to mitigate effects of pressurized process fluid.

FIG. 4 is a chart of pH sensor response to various pressures for a pH sensor using a cylinder-shaped reference junction.

FIG. 5 is a chart of pH sensor response to various pressures for pH sensors using ring-shaped reference junctions.

FIG. 6A is a cross-sectional view of a pH sensor having a ring-shaped reference junction.

FIG. 6B is an enlarged perspective view of a ring-shaped reference junction.

FIG. 7A is a cross-sectional view of a pH sensor having a cylindrical-shaped reference junction.

FIG. 7B is an enlarged perspective view of a cylindrically-shaped reference junction.

FIG. 8 is a chart illustrating various pressure step changes over time.

FIG. 9 is a chart of pH sensor response to the various pressure step changes of FIG. 8.

FIG. 10 is a chart showing pH variations for various process fluid flow rates at 30 psi.

FIG. 11 is a chart contrasting PH sensor reference potential for a reference electrode having a ring shape versus a ceramic reference electrode having a cylindrical shape.

FIG. 12 is a front elevation view of a pH sensor having a ring-shaped reference junction in accordance with an embodiment of the present invention.

FIG. 13 is a cross-sectional view of a pH sensor having a ring-shaped reference junction in accordance with an embodiment of the present invention.

FIG. 14 is a front elevation view of a flow-through pH sensor having a ring-shaped reference junction in accordance with an embodiment of the present invention.

### DETAILED DESCRIPTION OF ILLUSTRATIVE EMBODIMENTS

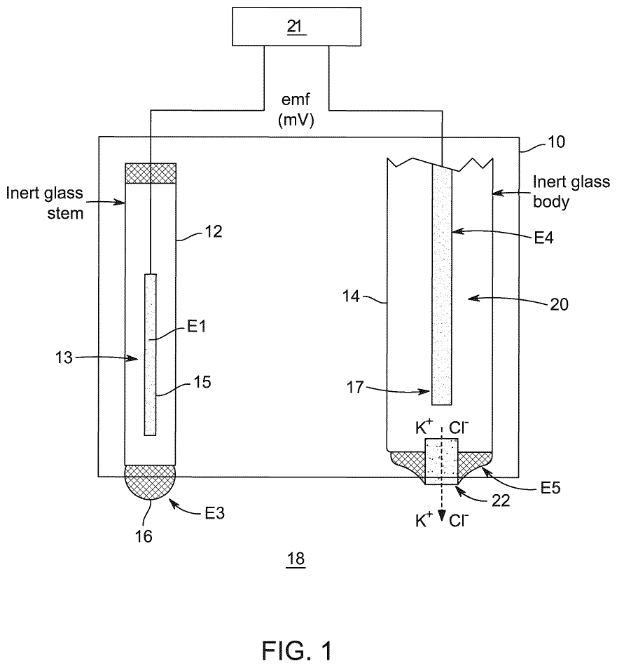

Before describing the various embodiments of the present invention, it is useful to first describe pH measurement basics. FIG. 1 is a diagrammatic view illustrating basics of pH measurement. pH measurement is typically conducted using a pH sensor 10, which typically comprises a glass electrode 12 and a reference electrode 14. The glass electrode 12 is filled with a pH fill solution 13 and features a specialized glass membrane 16 sensitive to hydrogen ions. When immersed in a solution, hydrogen ions from the solution interact with glass membrane 16, generating a potential (denoted by E3 in FIG. 1). This potential difference is directly proportional to the pH of the solution 18. The reference electrode 14 is often filled with a solution 20 of known pH (typically potassium chloride) that furnishes a stable reference potential for the measurement (illustrated by E4 and E5 in FIG. 1). When connected to a pH meter 21, the electromotive force (EMF) between the glass electrode and the reference electrode is measured (E_{pH}−E_{ref}), and the pH of the solution is derived from this voltage. The pH meter 21 converts the voltage reading into a pH value using a calibration curve. Under ambient conditions, the reference potential (E4 and E5) remains stable, ensuring an accurate and stable pH measurement.

The EMF (E_{pH}−E_{ref}) measured by the pH meter 21 is a function of the various potentials E1-E5 of the sensor as follows: E_{pH}−E_{ref}=E1+E2−E4−E5+E3=E0+E3. E1 is the potential between the AgCl/Ag wire 15 and the glass internal fill solution 13. E2 is the potential between the glass internal fill solution 13 and the inner side of the pH glass 16. E3 is the potential between the process liquid 18 and the outer side of the pH glass 16. E4 is the potential between Ag/AgCl wire 17 of reference electrode 14 and reference fill solution/gel 20. E5 is the potential between the pH reference junction 22 and process liquid 18. E1, E2, E4, and E5 are constants and can thus be combined as E0.

However, under changing pressure and flow conditions, the process liquid is sometimes able to infiltrate back into junction 22, or otherwise destabilize the equilibrium of ion flow out of junction 22, causing a modification in the potassium chloride (KCl) concentration inside junction 22. This occurrence results in an increase of reference impedance and change in reference potential near the junction surface (E5).

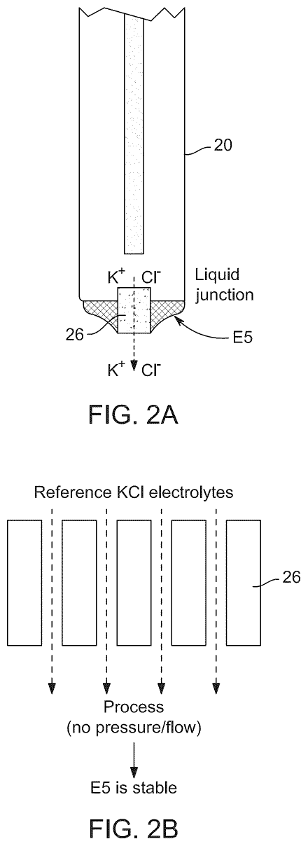

FIG. 2A. is a diagrammatic view of a known cylinder-shaped reference electrode 20 having a porous ceramic 26 as the material of junction 22. A pH sensor employing reference electrode 20 exhibited a response of approximately 0.2 to 0.5 pH units with a step change in process fluid 18 pressure from 10 to 90 psi, as depicted in FIGS. 2B and 2C. As can be seen in FIG. 2B. when there is no pressure of flow in the process fluid, the flow of electrolyte through porous reference junction is consistent and E5 is stable. However, when the process fluid has pressure or flow fluctuations, the flow of electrolyte through porous reference junction becomes inconsistent and E5 becomes unstable. Thus, reference electrode 20 is generally limited to sensing application for only processes with low process fluid pressures and low process fluid flow rates.

FIG. 2D is a chart of pH sensor response to varying process fluid pressures. FIG. 2D shows a pair of pH sensor responses 30, 32 to variations 34 in pressure of tap water. As can be seen, while the pH of the tap water does not change, the sensor response varies significantly with the applied pressure of the tap water.

To address this issue, efforts have been made to apply an internal pressure to the pH sensor's reference electrode, effectively mitigating the impact of external process pressure by expelling the reference electrolyte through the junction. The minimum internal pressure necessary for the sensor generally depends on the magnitude of the external process pressure and can be particularly demanding when the latter is high (e.g., 90 psi). The heightened requirement for a high internal reference chamber pressure may also present challenges in mechanical design and subsequent manufacturing process development.

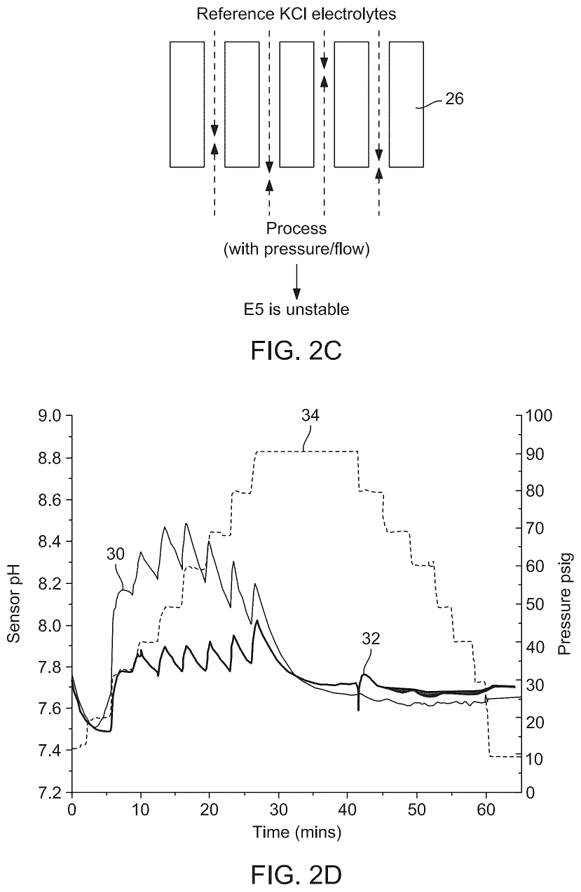

FIG. 3 is a chart of reference chamber pressure decay for a reference electrode that employs pressurization to mitigate effects of pressurized process fluid. As can be seen, when a reference chamber of a reference electrode is pressurized to approximately 90 psi, the pressure will slowly decay. As shown, after about 180 days, the pressure has dropped to less than 35 psi. This decay of reference chamber pressure over time for a pH sensor, is the main cause of limited pH sensor lifespan and/or shelf life for devices that employ the pre-pressurized reference technology.

Another approach to mitigating the effects of pressure and flow on reference electrodes involves the utilization of polyethylene glycol (PEG)-added reference gel. Both a higher viscosity reference solution and a solidified reference gel have demonstrated significantly improved pH stability while subjecting the process liquid pressure to a range from 10 to 90 psi. However, the reproducibility of prototype sensors using these PEG-added gels may be limited. It is believed that such limitation is primarily due to the utilization of cylindrically-shaped ceramic junctions. Furthermore, additional study is needed to verify the temperature effects, stability, and extractables and leachables of new gels with PEG. These challenges pose obstacles to the widespread application of the reference gel with PEG in large-scale scenarios.

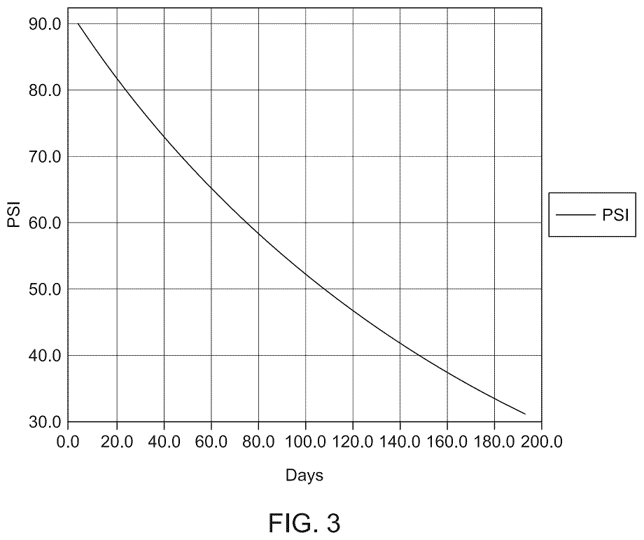

FIG. 4 is a chart of pH sensor response to various pressures for a pH sensor using a cylinder-shaped reference junction. Sub-region 36 of FIG. 4 shows an illustrative pH sensor having a cylindrically-shaped reference junction 38 formed of polytetrafluoroethylene (PTFE). The chart shows reference junction resistance in kiloohms (kohms) for three sensors in response to an initial no pressure condition and then higher and higher pressures. As can be seen, as the pressure increases, the reference resistance of all three sensors increases substantially. In fact, the reference resistance of all three sensors is above 500 kohm when the pressure is at 25 pounds per square inch gauge (psig). Additionally, traces 40, 42, and 44 indicate that the reference resistance of the different reference junctions do not vary in a uniform manner.

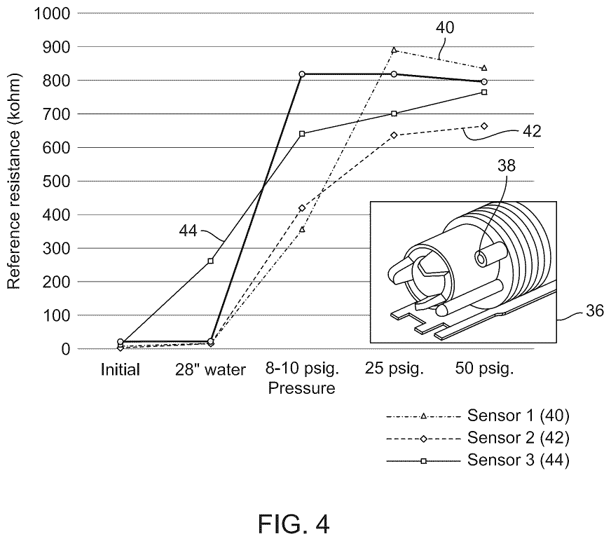

FIG. 5 is a chart of pH sensor response to various pressures for pH sensors using ring-shaped reference junctions. Sub-region 50 of FIG. 5 shows an illustrative pH sensor having a ring-shaped reference junction 52 formed of PTFE. The chart shows reference junction resistance in kohms for three sensors in response to an initial no pressure condition and then higher and higher pressures. As can be seen, as the pressure increases, the reference resistance of all three sensors increases from about 2 kohms to between 4 and 5 kohms. Additionally, traces 54, 56, and 58 indicate fairly uniform variation in response to pressure. Thus, employing a ring-shaped design with the PTFE material kept the reference resistance independent of pressure, maintaining it as low as 5 kohm at 50 psig. It should be noted that while embodiments include a ring-shaped reference junction, the ring need not be continuous and embodiments include reference junctions that include circular portions and not a solid ring.

To maintain consistent pH performance under high pressure and flow conditions, it is important to maintain and/or protect the reference potential, representing the potential between the process liquid and the pH junction material. The stability of the reference potential depends on maintaining the KCl concentration in the junction materials consistent with that in the reference chamber, or at least in a stable gradient between. This task is complicated by changes in pressure and flow. As shown above, ring-shaped reference junctions are able to provide better stability in response to pressure and flow variations. The correlation between high reference resistance and elevated reference junction potential was observed to cause greater pH errors. Improved high-pressure and/or high flow performance of pH sensors utilizing ring-shaped PTFE reference junctions was attributed to the important roles of junction shape, surface area, and microstructure in preserving stable junction potential and ensuring accurate pH readings.

While ring-shaped PTFE reference electrodes are highly useful for high-pressure and/or high flow process conditions, they are limited in biopharmaceutical applications. This is because materials in the biopharmaceutical industry must be able to withstand Gamma sterilization. In Gamma sterilization a strong Gamma field (50 kGy) is applied to the device to kill all microbial life. It is thus very important that the materials of any biopharmaceutical pH sensor be able to withstand Gamma sterilization. Polytetrafluoroethylene is not compatible with strong Gamma irradiation as it is only able to withstand 5 kGy. Additionally, the reference junction material should ensure stringent control over the electrolyte (KCl) leak rate from the junction materials to uphold optimal ionic strength in low-conductivity solutions (<1 ms/cm).

Thus, for biopharmaceutical applications as well as any application that employs Gamma sterilization or otherwise exposes the device to higher levels of Gamma radiation than 5 kGy a different material is required for the reference junction.

The table below presents a compilation of potential reference junction materials that were evaluated along with their respective tolerance levels to gamma irradiation.

| Material | Tolerance Level (kGy) |
|---|---|
| Polyethylene (HDPE, LDPE, | 1000 |
| LLDPE, UHMW) | |
| Polystyrene | 10000 |
| Polysulfone | 10000 |
| Polyurethane | 10000 |
| Ultem ® PEI (polythermide) | >100 kGy, depending on grade |
| Epoxies | 1000 |
| Ceramic | >10000 |

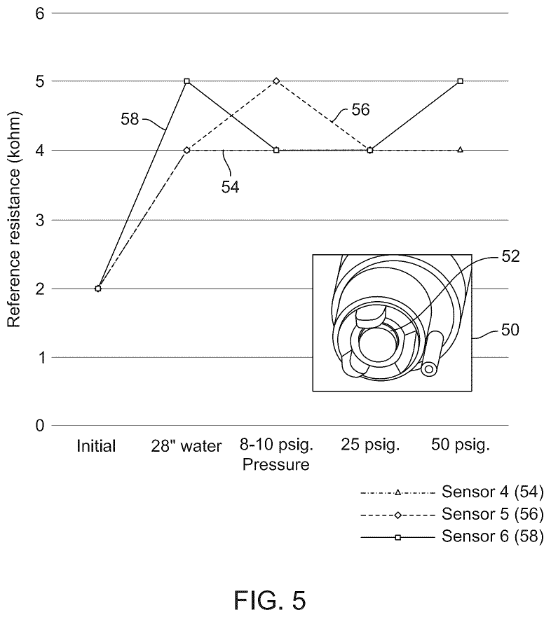

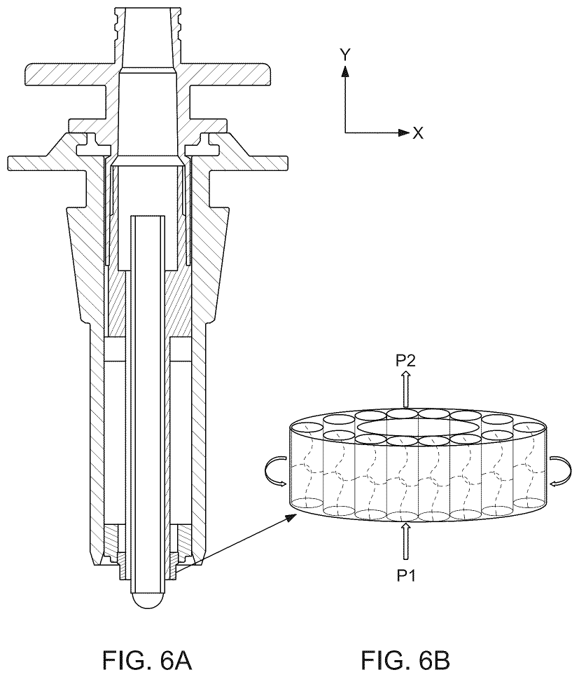

As can be seen, all materials listed in the table above are rated for exposure above 50 kGy. Since 50 kGy is the exposure required for Gamma sterilization, these materials are defined herein as Gamma-sterilizable as they are rated for exposure beyond 50 kGy. With the exception of ceramic, the Gamma-sterilizable materials are polymers. These materials are thus defined herein as Gamma-sterilizable polymeric materials. With these promising “Gamma sterilizable” materials, various designs were evaluated using computational fluid dynamics (CFD) modeling and research. The investigation focused on comparing the flow characteristics between a ring-shaped porous pH junction shown in FIGS. 6A and 6B and the cylinder-shaped porous pH junction shown in FIGS. 7A and 7B.

The key disparities that were identified are flow path, surface area, tortuosity, and pressure drop. In a ring-shaped porous pH junction (FIGS. 6A and 6B, flow can traverse both the interior of the ring and around its exterior, creating multiple distinct flow paths. This multi-path flow system can significantly affect overall flow distribution and pressure drop. The forces with different directions could be balanced, leading to a drop in pressure along the direction transverse to the longitudinal axis of the junction. Conversely, if the ring-shaped junction is divided into a series of cylinder-shaped junctions and one of them is used as a pH junction, the flow through this cylinder-shaped porous pH junction is primarily confined to its interior. As a result, there is considerably less flow length along the transvers axis compared to the ring shape. This reduces the chance for balancing the force from the reverse direction of flow and consequently leads to less pressure drop.

With respect to the consideration of surface area, a ring-shaped porous cylinder typically boasts a larger surface area compared to a solid cylinder of equivalent dimensions. This increased surface area facilitates enhanced fluid-solid interaction, potentially resulting in higher drag forces and pressure drop which better maintains the concentration of reference ions in the junction.

Tortuosity describes the convoluted path that fluid particles must follow as they move through a porous medium. It quantifies the deviation of the fluid flow path from a straight line. A higher tortuosity implies a longer effective path length for fluid flow, which increases the resistance to flow and leads to higher pressure drop. A higher tortuosity was designed for the ring-shaped porous pH junction than the cylinder-shaped porous pH junction.

With respect to the consideration of pressure drop, the pressure drop across a ring-shaped porous pH junction is influenced by flow path, larger surface area, and higher tortuosity. Consequently, this configuration may exhibit a higher pressure drop (P1-P2) compared to a cylinder-shaped porous pH junction (P1-P3), as shown in FIGS. 6A, 6B, 7A, and 7B.

In summary, although both configurations facilitate fluid flow through a porous medium, their geometric disparities lead to distinct flow characteristics and performance outcomes. Thus, it was determined that the pressure drop was significantly higher for the ring-shaped design of the pH junction, which could be further controlled by the microstructure design of flow path, porosity, surface area, and tortuosity. Consequently, the process liquid under high pressure achieved quicker equilibrium with the ring-shaped junction compared to the cylinder-shaped junction. As a result, the KCl concentration and reference junction potential remained more stable with the ring-shaped design and less influenced by process liquid with high pressure and flow rate.

For the materials identified in the table above, controlling porosity is very important for managing flow paths and influencing pressure drop, ensuring the stability of the pH junction potential against high-pressure, high-flow-rate process liquids. Various methods enable the creation of porous polymer materials, each with distinct advantages. The various methods include, without limitation, the foaming process, particulate leaching, gas dissolution and expansion, fiber reinforcement with dissolvable fibers, and 3D printing/additive manufacturing.

In the foaming process, introducing a blowing agent into polymer resin forms a cellular structure via decomposing gas bubbles during processing (e.g., extrusion or compression molding). Density and porosity are adjustable by varying agent type/amount and processing conditions.

In particulate leaching, polymer resin is mixed with sacrificial particles (e.g., PMMA, salt or sugar), shaping the material, then immersing it in a solvent that selectively dissolves the sacrificial particles, leaving pores. Control over pore size/distribution is achievable by adjusting particle characteristics, solvent, and processing conditions.

In gas dissolution and expansion, subjecting polymer materials to high-pressure gas followed by rapid depressurization causes gas expansion, creating pores. Precise pressure and temperature control in specialized equipment are necessary for desired pore structure.

In fiber reinforcement, dissolvable fibers (e.g., polyvinyl alcohol) are incorporated into the polymer matrix. Removing the dissolvable fibers post-shaping through washing or dissolution, results thus in a porous structure. This method enhances mechanical properties due to fiber reinforcement.

In 3D printing and additive manufacturing, techniques such as selective laser sintering or fused deposition modeling enable direct creation of porous structures from polymer powder or filament. Tailored porosity and pore size distribution are achievable by adjusting printing parameters (e.g., temperature, layer height, infill density).

By integrating sizing-treated reinforcing materials such as glass fibers or carbon nanotubes (CNTs) into the polymers listed in the table above and utilizing suitable fabrication methods, ring-shaped pH junctions can be manufactured with electrolyte (KCl) flow paths not affected by the process liquid with higher pressure and flow rate. This approach facilitates the production of composites with customized properties, including improved strength, stiffness and manufacturability.

Controlled porosity is realized using any of the above manufacturing techniques or combinations thereof. In some examples, Controlled porosity is achieved by incorporating pore-forming agents such as PMMA, followed by methods like hot pressing or solvent exchange with acetone or similar solvents. The reference junction material is fashioned into a ring or other symmetrical shape with a central void to accommodate the placement of pH sensing glass or other pH sensing elements capable of withstanding pressures up to 110 psi and high-flow-rate environments. Furthermore, these materials preferably adhere to stringent regulations, being free of animal-derived ingredients and complying with USP class VI, FDA 21 CFR 177.1520 requirements for polyolefin polymers, RoHS, REACH compliance, and clean room production standards. Additionally, the reference junction can include combinations of materials and such combination can include a specific ratio of class fibers, carbon nanotubes or similar materials known for their stability against gamma radiation of at least 50 kGy and resistance to chemical degradation.

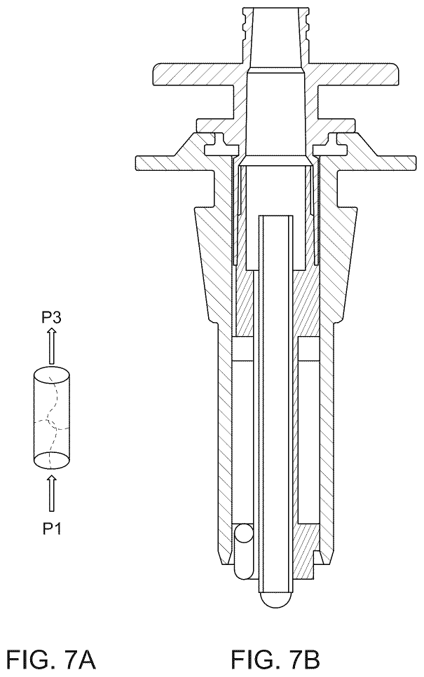

FIG. 8 is a chart illustrating various pressure step changes over time. As shown in FIG. 8, a number of step pressure changes are applied beginning with a pressure of 10 psi and extending to 90 psi at approximately time 5000 seconds. The pressure steps shown in FIG. 8 are applied to a pH sensor having a ring-shaped reference electrode formed of one particular polymeric Gamma-sterilizable material (ultra-high molecular weight polyethylene-UHMW-PE). In the UHMW-PE sensor the reference junction (porosity and flow path) were controlled by particulate leaching.

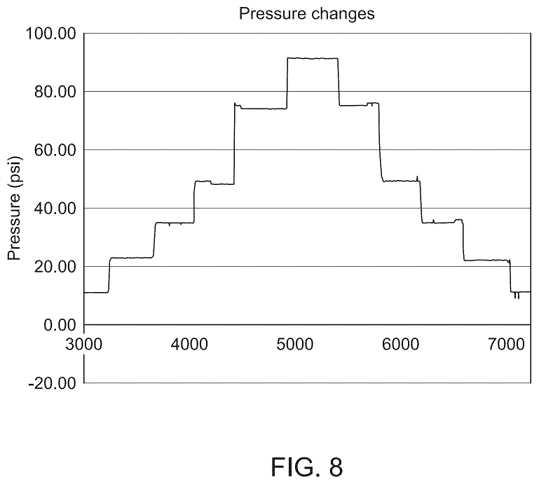

The response of the pH sensor to the pressure steps applied in FIG. 8 is shown in FIG. 9 along with responses of a pair of pH sensors that employ PTFE ring-shaped reference junctions. The responses of the pH sensors that employ PTFE ring-shaped reference junctions are indicated at reference numerals 100 and 102. The response of the pH sensor employing the UHMW-PE reference junction is indicated at numeral 104. As can be seen, the UHMW-PE pH sensor tracks the response of the PTFE-based sensors very well for pressure variations ranging to 90 psi. Additionally, the UHMW-PE sensor is gamma sterilizable and is thus suitable for the biopharmaceutical industry.

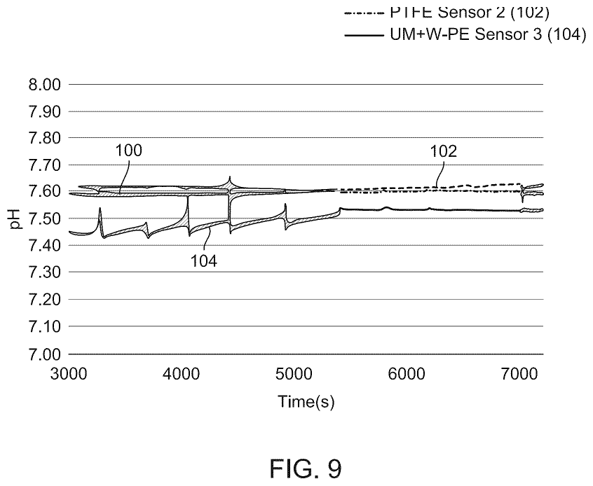

FIG. 10 is a chart showing pH variations for various process fluid flow rates at 30 psi. As shown in FIG. 10, pH variations for the pH sensor having the UHMW-PE ring-shaped reference junction were compared to pH variations for a pair of pH sensors using PTFE ring-shaped reference junctions for flow rates ranging from 5 gallons/minute to 17 gallons/minute. Reference numerals 106, 108 indicate pH variations of the pH sensors having ring-shaped PTFE reference junctions, while numeral 110 indicates pH variations of the pH sensor having a ring-shaped UHMW-PE reference junction. Throughout the test, conducted between flow rates of 5 to 17 gallons per minute at a fixed pressure of 30 psi, minimal pH variation of less than 0.05 was observed. Thus, the UHMW-PE pH sensor tracks the response of the PTFE-based sensors very well for variations in flow at elevated pressures.

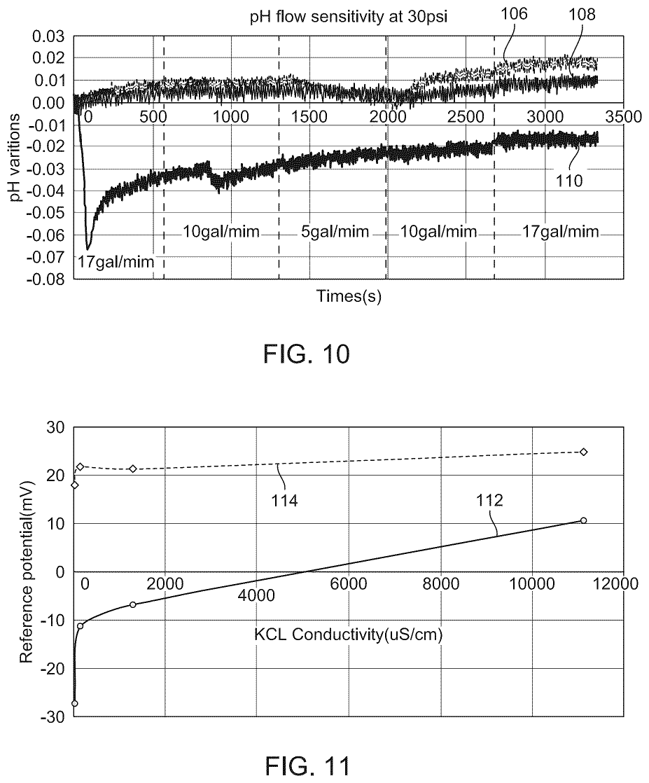

FIG. 11 is a chart contrasting pH sensor reference potential for a reference electrode having a ring shape versus a ceramic reference electrode having a cylindrical shape. FIG. 11 illustrates the ionic strength test comparing the reference junction made with a ring-shaped UHMW junction and a cylinder-shaped ceramic junction in liquid with NIST traceable solution conductivity (148, 1409, 12856 and 11343 us/cm), KCL concentrations of 0.001, 0.01, 0.1, and 1 M). The response of the cylinder-shaped ceramic junction is indicated at reference numeral 112, while the response of the ring-shaped UHMW junction is indicated at reference numeral 114. As can be seen, the variation in response 114 is significantly less than the variation of response 112 across the illustrated KCl conductivity range (0-120000 uS/cm).

The composition and concentration of the sample solution can have a significant impact on the reference junction potential. In solutions with low conductivity, there might be a scarcity of ions for the reference junction to interact with the process liquid. If the reference junction cannot maintain a sufficient KCl leak rate to complete the electrical circuit, it will result in higher reference resistance and reference junction potential in pH measurement under low conductivity process liquid. This limitation confines the application of pH sensors made from such junctions to processes with only a limited high conductivity range.

An effective reference junction with optimized microstructure and materials design should be capable of maintaining a consistent reference junction potential across a wide range of conductivity. For instance, the KCl leak rate of the ring-shaped UHMW junction was fine-tuned to uphold excellent ionic strength across a broad conductivity spectrum, ranging from 148 uS/cm to 11343 uS/cm, as illustrated in FIG. 11. In comparison, the ring-shaped UHMW junction exhibited a maximum offset of only 6.7 mV, notably lower than the approximately 38 mV offset typically observed for cylindrical ceramic junctions commonly employed in current commercialized single-use pH sensors shown at reference numeral 112 in FIG. 11.

In the biopharmaceutical industry, low conductivity buffers (~1 mS/cm) are frequently utilized to calibrate pH sensors. By incorporating the ring-shaped UHMW junction in this expansive conductivity range of process liquid, more than ~0.3 pH error was effectively mitigated with liquid of conductivity range from 148 to 1409 uS/cm. This underscores the importance of utilizing advanced reference junction designs to ensure accurate pH measurements across a wide array of process conditions, particularly in industries with stringent quality requirements such as biopharmaceutical manufacturing.

A number of sensors utilizing embodiments described herein were constructed. All such sensors demonstrated highly consistent performance under varying pressure conditions, showcasing the promising reproducibility of both the materials and manufacturing processes. This achievement represents an important increase in performance over known designs.

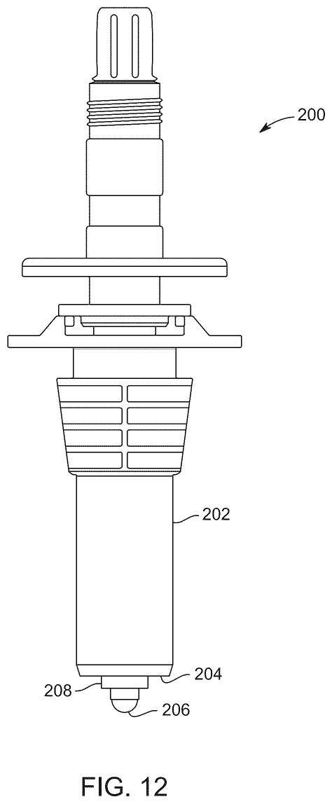

FIG. 12 is a front elevation view of a pH sensor having a ring-shaped reference junction in accordance with an embodiment of the present invention. pH sensor 200 includes a sensor body 202 having a distal end 204 that is configured to be exposed to a liquid. PH sensing glass bulb 206 is disposed on distal end 204. A ring-shaped electrode 208 surrounds glass bulb 206 and is formed of a gamma-sterilizable material in accordance with embodiments described herein. The combination of the ring-shape and the gamma-sterilizable reference junction material allows sensor 200 to be used in biopharmaceutical applications in situations with elevated pressure and/or flow rates.

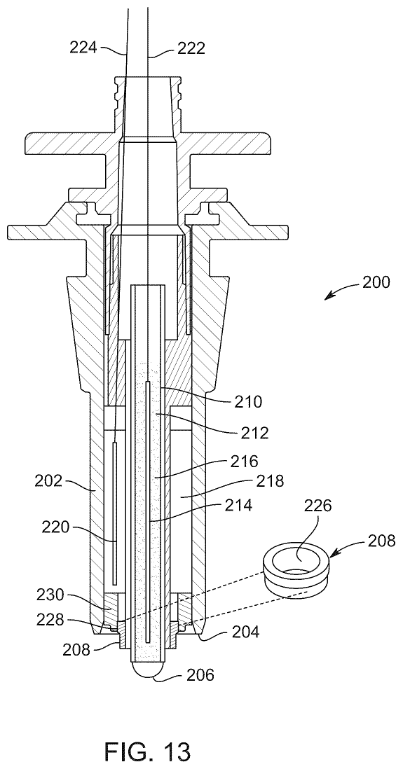

FIG. 13 is a cross-sectional view of the pH sensor of FIG. 12. As can be seen, glass bulb 206 is part of pH glass electrode 210 having an internal chamber 212 in which a AgCl/Ag wire 214 and the glass internal fill solution 216 is disposed. Within sensor body 202 an annular reference electrode chamber surrounds pH glass electrode 210 and is filled with electrolyte 218, such as potassium chloride. An Ag/AgCl wire 220 is positioned within electrolyte 218. Conductors 222 and 224 are coupled to wires 214 and 220, respectively. Ring-shaped, gamma-sterilizable reference junction 208 is disposed proximate distal end 204 about glass electrode 210. In the illustrated embodiment, reference junction 208 is ring-shaped with an inner aperture 226 that is sized to pass the outside diameter of glass electrode 210. Reference junction 208 also includes shoulder 228 having an outside diameter that is received by end 230 of sensor 200.

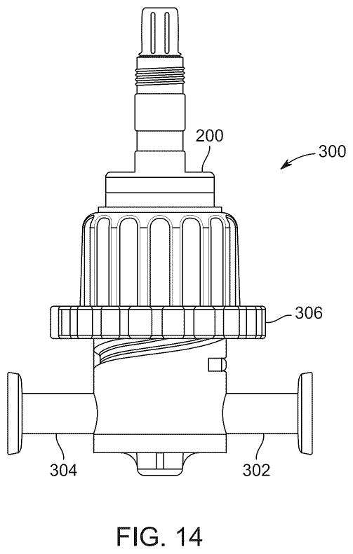

FIG. 14 is a front elevation view of a flow-through pH sensing system having a pH sensor with a ring-shaped reference junction in accordance with an embodiment of the present invention. FIG. 14 shows a flow cell design, integrating the pH sensor 200 shown in FIGS. 12 and 13, including a pressure engage feature 306 along with customizable tubing or connections 302, 304.

Although the present invention has been described with reference to preferred embodiments, workers skilled in the art will recognize that changes may be made in form and detail without departing from the spirit and scope of the invention. For example, while embodiments of the present invention have been described with respect to a pH sensor having a glass bulb pH electrode, any suitable pH sensing electrode, such as a thin film electrode or a polymer-based electrode can be used.

What is claimed is:

1. A pH sensor comprising:
a sensor body;
a pH electrode disposed within the sensor body, the pH electrode being configured to be exposed to a liquid; and
a reference electrode having an electrolyte therein, the reference electrode including a reference junction in contact with the electrolyte and is configured to contact the liquid; the reference junction being shaped as a ring and formed of a gamma-sterilizable material.

2. The pH sensor of claim 1, wherein the gamma-sterilizable material is a polymeric gamma-sterilizable material.

3. The pH sensor of claim 2, wherein the polymeric gamma-sterilizable material is selected from the group consisting of polyethylene, polystyrene, polysulfone, polyurethane, polythermide, and epoxy.

4. The pH sensor of claim 3, wherein the reference junction is formed of ultra-high molecular weight polyethylene (UHMW-PE).

5. The pH sensor of claim 1, wherein the gamma-sterilizable material has a porosity that is controlled by a manufacturing process of the reference junction.

6. The pH sensor of claim 5, wherein the manufacturing process is selected from the group consisting of foaming, particulate leaching, gas dissolution and expansion, fiber reinforcement with dissolvable fibers, and additive manufacturing.

7. The pH sensor of claim 1, wherein the reference junction incorporates sizing materials.

8. The pH sensor of claim 1, wherein the reference junction is formed, at least partially, of glass fibers.

9. The pH sensor of claim 8, wherein a ratio of glass fibers to other materials of the reference junction is controlled during manufacture of the reference junction.

10. The pH sensor of claim 1, wherein the reference junction is formed, at least partially, of carbon nanotubes.

11. The pH sensor of claim 10, wherein a ratio of carbon nanotubes to other materials of the reference junction is controlled during manufacture of the reference junction.

12. The pH sensor of claim 1, wherein the reference junction has a maximum offset of less than 7.0 mV for variations in electrolyte conductivity ranging from 148 μS/cm to 11343 μS/cm.

13. The pH sensor of claim 1, wherein the ring-shaped reference junction surrounds the pH electrode.

14. The pH sensor of claim 1, wherein the pH electrode is selected from the group consisting of a glass bulb electrode, a thin film electrode, and a polymer-based electrode.

15. A flow cell incorporating the pH sensor of claim 1, the flow cell having a conduit with an inlet and an outlet.

16. The flow cell of claim 15, and further comprising a pressure engage feature.

17. A reference junction for a pH sensor, the reference junction comprising:
a ring-shaped structure formed of a gamma-sterilizable material; and
wherein the ring-shaped structure has a controlled porosity to provide a controlled electrolyte leak rate in applications having pressure in excess of 100 psi.

18. The reference junction of claim 17, wherein the reference junction has a maximum offset of less than 7.0 mV for variations in electrolyte conductivity ranging from 148 μS/cm to 11343 μS/cm.

19. The reference junction of claim 17, wherein an inner aperture of the ring-shaped structure is sized to receive a pH glass electrode.

20. The reference junction of claim 17, wherein the ring-shaped structure includes a shoulder.

21. The reference junction of claim 20, wherein the shoulder includes an outer diameter configured to be mounted within a body of the pH sensor.

22. The reference junction of claim 17, wherein the gamma-sterilizable material is a polymeric gamma-sterilizable material.
